(19) United States
(12) Patent Application Publication
(10) Pub. No.: US 2025/0085159 A1
(43) Pub. Date: Mar. 13, 2025

(54) PYRANOMETER INCLINOMETERS AND RELATED DEVICES, SYSTEMS, AND METHODS

(71) Applicants: Svetlana Nichols, Phoenix, AZ (US); Cody Brown, Chandler, AZ (US)

(72) Inventors: Zachary Nichols, Phoenix, AZ (US); Cody Brown, Chandler, AZ (US)

(21) Appl. No.: 18/827,451

(22) Filed: Sep. 6, 2024

Related U.S. Application Data
(60) Provisional application No. 63/537,155, filed on Sep. 7, 2023.

(51) Int. Cl. G01J 1/42; G01J 1/04

(52) U.S. Cl. CPC G01J 1/42; G01J 1/0403; G01J 2001/4285

(57) ABSTRACT

This disclosure includes automatic leveling bases comprising an adapter plate, a top housing on said adapter plate, a bottom housing comprising an inclinometer and one or more motors, and a bellows between said top housing and said bottom housing. Also disclosed herein are systems for measuring solar irradiance comprising: an automatic leveling base comprising an adapter plate connected to a bottom housing, said bottom housing comprising an inclinometer and one or more motors, and a pyranometer attached to said automatic leveling base, wherein said one or more motors are configured to adjust an angle of said pyranometer. Additionally disclosed herein are methods of measuring solar irradiance comprising: inclining a pyranometer to a specific angle via an automatic leveling base and measuring the output of said pyranometer.

### RELATED APPLICATIONS

This application claims the benefit of U.S. Prov. Pat. App. No. 63/537,155, entitled “PYRANOMETER INCLINOMETERS AND RELATED DEVICES, SYSTEMS, AND METHODS” and filed on Sep. 7, 2023, the entire description, claims, and drawings of which is fully incorporated by reference herein.

### BACKGROUND OF THE INVENTION

### Field

This disclosure is directed generally toward solar devices, systems, and methods, such as utility scale solar power plants and devices for use therewith. More specifically, this disclosure is directed toward automatically leveling pyranometers for measuring solar irradiance, including solar irradiance incident to solar panels.

### Description of the Related Art

Pyranometers are widely used in the solar power generation industry to measure global horizontal and plane of array solar radiation, i.e. the combined radiation directly from the sun and diffuse solar radiation. Pyranometers can be used as a “true north” against which solar panel electricity output can be compared to measure efficiency and determine when panels require cleaning. Some pyranometers are configured to sense the global horizontal solar irradiance, which is the light falling on the Earth's surface throughout the day. Other pyranometers, known as “plane of array” (“POA”) pyranometers are configured to detect solar irradiance as the panels track from east to west throughout the course of the day, i.e. the light received from a specific angle.

In the utility scale solar power and generation industry, pyranometers are often used to detect the titled irradiance incident to the plane of array of solar panels. Often, many pyranometers are deployed to measure the titled irradiance incident to the planes of array for multi-panel arrays. The outputs of the pyranometers can then be compared to models designed to predict irradiance based on various factors, such as weather, to reliably monitor array performance. Some applications utilize both horizontal and tilt configured pyranometers.

To function properly, pyranometers must be leveled or inclined at a specific angle, and any small inclination relative to level or the specific angle will result in inaccurate pyranometer data. Accordingly, pyranometers may be equipped with fixtures designed to enable users to adjust the incline of the devices. FIG. 1 shows a prior art leveling fixture 100, such as that offered by Apogee Instruments, Inc. of Utah. While pyranometers at solar power plants may be leveled when installed, a small perturbation can cause the device to lie in an incorrect plane, resulting in unreliable data. The leveling fixture 100 poses a particular challenge in solar power systems, which are often in remote locations and are typically left unattended for considerable periods of time. As a result, workers must frequent solar power plants to check and re-level pyranometers mounted to the leveling fixture 100. The prior art leveling fixture 100 comprises a bubble level 102 and leveling screws 104. A pyranometer may be mounted on top of and/or parallel to the leveling fixture 100, after which the leveling screws 104 may be adjusted such that an air bubble in the bubble level 102 is centered in a circle therein. The centering of said air bubble level indicates that the leveling fixture 100, and by extension the mounted pyranometer, is level.

### SUMMARY OF THE DISCLOSURE

One embodiment of an automatic leveling base according to the present disclosure includes an adapter plate, a top housing on the adapter plate, a bottom housing with an inclinometer and one or more motors, and a bellows between the top and bottom housings.

One embodiment of a system according to the present disclosure includes an automatic leveling base comprising an adapter plate connected to a bottom housing. The bottom housing comprises one or more inclinometers and one or more stepper motors. The system further includes a pyranometer attached to the automatic leveling base.

One embodiment of a method according to the present disclosure includes inclining a pyranometer to a specific angle via an automatic leveling base, and measuring the output of the pyranometer.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIG. 1 shows a prior art leveling fixture.

FIG. 2 shows a pyranometer mounted to an automatic leveling base according to one embodiment of the present disclosure.

FIG. 3 shows an exploded view of the automatic leveling base shown in FIG. 2.

FIG. 4 shows a partially transparent front view of the automatic leveling base shown in FIG. 2.

FIG. 5 shows a top perspective view of a bottom housing of the automatic leveling base shown in FIG. 2.

FIG. 6 shows a partially transparent bottom perspective view of the bottom housing shown in FIG. 2.

FIG. 7 shows a pyranometer mounted to an automatic leveling base according to another embodiment of the present disclosure.

FIG. 8 shows a top perspective view of a bottom housing of the automatic leveling base shown in FIG. 7.

FIG. 9 shows a partially transparent top perspective view of the bottom housing shown in FIG. 7.

FIG. 10 shows a top view of the bottom housing shown in FIG. 7.

FIGS. 11 and 12 show partially transparent front views of the bottom housing shown in FIG. 7.

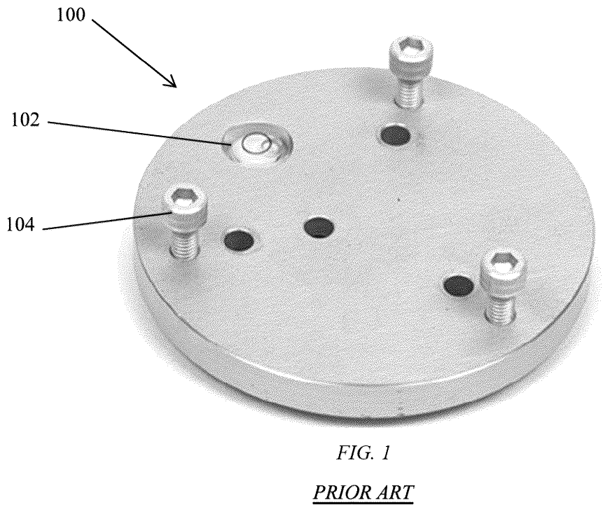

### DETAILED DESCRIPTION OF THE INVENTION

The present disclosure includes automatic leveling bases to be used in adjusting the angle to which a pyranometer is inclined. In some embodiments, the automatic leveling base comprises an adapter plate, a top housing, bellows, and a bottom housing which can itself further comprise one or more inclinometers, motors, electronics, and/or swivels. The automatic leveling bases described herein can utilize inclinometers and motors to level pyranometers without the need for workers to manually adjust the incline of the devices. In certain embodiments, the electronic is configured to communicate with a software, and provides the software with irradiance measurements. In some embodiments, the automatic leveling base and/or pyranometer is mounted to a solar panel and/or at a variable orientation, while in other embodiments it is mounted to a meteorological station and/or at a constant orientation, such as vertical.

Throughout this description, the preferred embodiment and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “vertical,” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology is used herein for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, from variations the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. Like elements among embodiments are referenced herein with the same reference numerals, except where differences are articulated.

It is understood that while the present application is written with solar power generation generally in mind, the devices, methods, systems, and concepts herein could be applied to fields other than solar power generation, as would be understood by one of skill in the art, including but not limited to weather monitoring, agriculture, building automation, and videography/photography.

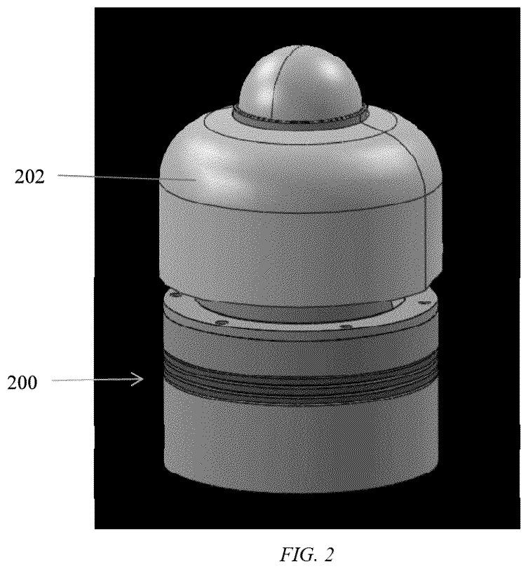

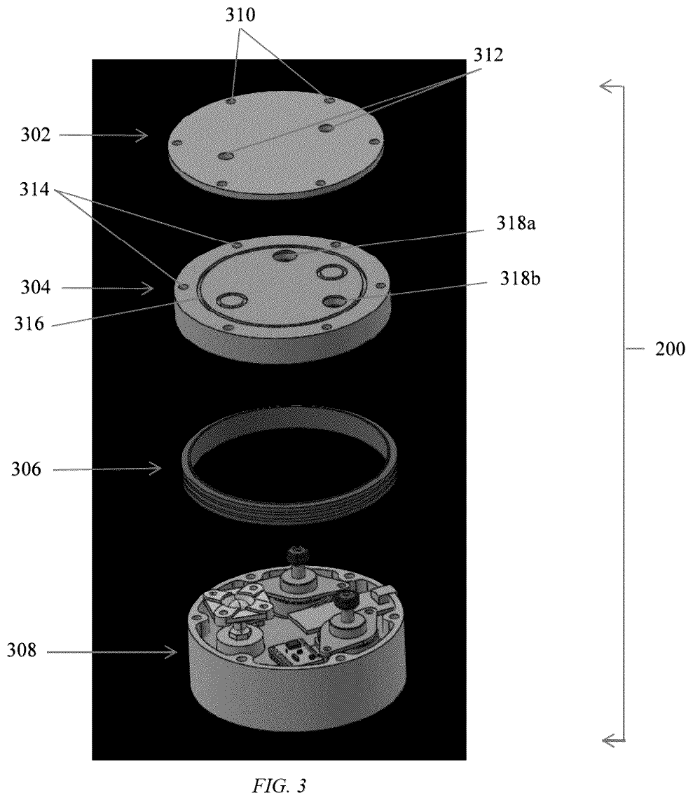

FIG. 2 shows a pyranometer 202 mounted to an embodiment of an automatic leveling base 200 according to an embodiment of the present disclosure. FIG. 3 shows the automatic leveling base 200 of the embodiment shown in FIG. 2. The automatic leveling base 200 includes an adapter plate 302, a top housing 304, bellows 306, and a bottom housing 308 (discussed in further detail herein), though it is understood that fewer, more, or different components are possible. Relatedly, while a singular pyranometer 202 is shown in FIG. 2, it is understood that automatic leveling bases 200 according to the present disclosure may support a plurality of pyranometers 202 and/or other sensors.

The adapter plate 302 can be used to connect the remainder of the automatic leveling base 200 to the pyranometer 202. While the adapter plate 302 shown in FIG. 3 is approximately disc-shaped, it is understood that other shapes are possible, such as squares, hexagons, triangles, and other shapes known in the art. The diameter of the adapter plate 302 may be 1 to 12 inches, 2 to 8 inches, or 3 to 6 inches. It is understood that these ranges are merely exemplary, and other diameters of the adapter plate 302 are contemplated. The adapter plate 302 may be shaped and sized according to and/or matched to the size and shape of the pyranometer 202. The adapter plate 302 may be made of a variety of materials, such as metals, plastics, and other materials known in the art. The adapter plate 302 may be constructed from a material capable of withstanding the elements and sunlight, such as, for example, metal (e.g.) aluminum, plastic, and/or other materials known in the art.

In some embodiments according to the present disclosure, adapter holes 310 are formed through the adapter plate 302. In a specific embodiment, six adapter holes 310 are spaced equidistantly around the approximate perimeter of the adapter plate 302. While FIG. 3 shows an adapter plate 302 with six adapter holes 310, it is understood that other numbers of adapter holes 310 are possible, such as one or more, two or more, three or more, four or more, or five or more. In some embodiments, connectors or fasteners such as bolts—through the adapter holes 310—are used to connect the adapter plate 302, the top housing 304 (discussed further below), and/or the bottom housing 308 (also discussed in more detail below). It is understood that other mechanisms may be used to attach the adapter plate 302 to the top housing 304 and/or to the bottom housing 308, including screws, rivets, adhesives, nails, and other mechanisms known in the art.

In some embodiments according to the present disclosure, the adapter plate 302 contains mounting holes 312, which may be formed through the entire thickness of the adapter plate 302. Connectors may be used through mounting holes 312 to secure the pyranometer 202 to the adapter plate 302 and the remainder of the automatic leveling base 200. It is understood that other mounting mechanisms are possible. For example, the pyranometer 202 may be mounted to the adapter plate 302 via bolts, screws, fasteners, adhesives, rivets, and other mechanisms known in the art. It is further understood that the pyranometer 202 and the adapter plate 302 may form one integral component, rather than two separate pieces secured by a mounting mechanism. Various mounting hole 312 configurations of the adapter plate 302 may be used to adapt different pyranometers 202 from different manufacturers to the same automatic leveling base 200.

The top housing 304 shown in FIG. 3 is cylindrical in shape, but one of skill in the art would understand that other shapes, such as rectangular, triangular, and hexagonal prisms, or other shapes known in the art. In some embodiments according to the present disclosure, the cross sectional shape and size of the top housing 304 is identical or substantially identical to that of the adapter plate 302. The top housing 304 may be made of many different materials, such as metals, plastics, and other materials known in the art. The top housing 304 may be made from a material capable of withstanding the elements and sunlight, such as aluminum. One of skill in the art would recognize that other materials may be used.

In some embodiments, the top housing 304 contains top housing connector holes 314, which may not pass through the entire thickness of the top housing 304. In a specific embodiment, the number of top housing connector holes 314 is equal to the number of adapter holes 310. In an even further specific embodiment, the location of top housing connector holes 314 matches the location of adapter holes 310, such that connectors may pass through both the adapter holes 310 and thread into the top housing connector holes 314 to secure the adapter plate 302 to the top housing 304. One of skill in the art would recognize that other means of attaching the adapter plate 302 to the top housing 304 are possible, such as screws, bolts, adhesives, rivets, welds, and other fastening means known in the art. Further, the top housing 304 and the adapter plate 302 may be formed as one integral unit, rather than as discrete pieces.

In some embodiments according to the present disclosure, the top housing 304 includes a channel 316. An O-ring may be seated in the channel 316 to provide a seal between the top housing 304 and the adapter plate 302, thereby preventing or reducing the unwanted ingress of dust, debris, and moisture into the device. Gaskets and other sealing mechanisms known in the art may be used instead of an O-ring. In some embodiments, the channel 316 is located on the adapter plate 302, and in other embodiments, both the adapter plate 302 and the top housing 304 contain corresponding channels 316. The top housing further includes, in some embodiments, leveling holes 318a and 318b. In specific embodiments, the leveling holes 318a and 318b pass through the entire thickness of the top housing 304. The leveling holes 318a and 318b allow swivels 504a and 504b (discussed in detail below) to pass through the top housing 304 to directly abut and/or connect to the adapter plate 302.

The top of the bellows 306 is connected to the surface of the top housing opposite the adapter plate 302. The bottom of the bellows 306 is connected to the top of the bottom housing 308. The bellows 306 are made of a flexible material capable of withstanding the elements and sunlight, such as Butyl, EPDM, Polyurethane, and other materials known in the art. In some embodiments according to the present disclosure, the bellows 306 have concertinaed or convoluted sides which permit the bellows to expand and contract. As a result, the pyranometer may be inclined relative to the bottom housing 308 without the unwanted ingress of debris and moisture into the automatic leveling base 202. One of skill in the art would recognize that other means may be used to provide free movement of the pyranometer 202 while simultaneously preventing foreign material from entering the device, such as flexible fabrics and other means known in the art. FIG. 4 shows a partially transparent front view of the assembled automatic leveling base 200.

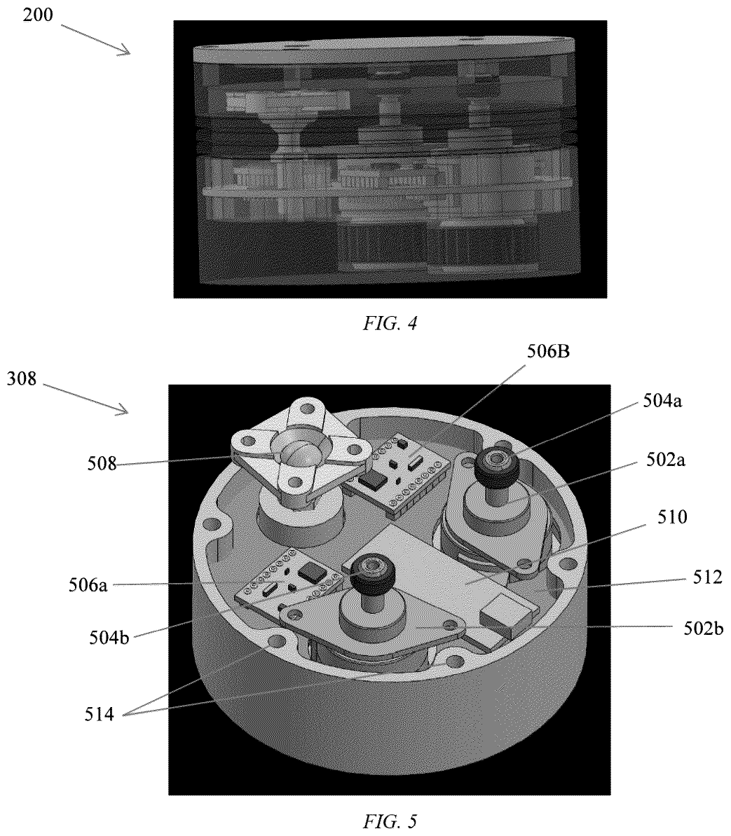

FIG. 5 shows the bottom housing 308. In some embodiments according to the present disclosure, the bottom housing 308 includes one or more motors 502a and 502b, one or more swivels 504a and 504b, one or more inclinometers 506a and 506b, a fixed swivel 508, an electronic 510, a circuit board 512, and/or circuit board holes 514, through which the circuit board 512 can be mounted to the bottom housing 518 whether directly or otherwise. It is understood that some embodiments may include multiple of any of these elements, or fewer than all of these elements, and may or may not include additional elements.

In a specific embodiment, the motors 502a and 502b are stepper motors. The motors 502a and 502b are connected to the swivels 504a and 504b, which in turn are connected to the top housing 304. Each of the motors 502a and 502b may be connected to a respective swivel (e.g., in a 1:1 relationship), though it is understood that other embodiments are possible. The swivels linkage 504a and 504b may be spherical, semispherical, a frustum, or other shapes known in the art. The motors 502a and 502b may be capable of moving independently of one another. By raising and lowering the swivels 504a and 504b via the motors 502a and 502b, the top housing 304, and by extension, the pyranometer 202, is inclined relative to the bottom housing 308, without the need for manual angle adjustment by a worker. While two motors 502a, 502b are shown in FIG. 5, it is understood that less or more motors are possible, such as one, three, four, or more motors. One of skill in the art would recognize that other components may be used rather than swivels 504a, 504b to transfer movement of the motors 502a, 502b to the pyranometer 202, such as, for example, direct connection from the motors 502a, 502b to the top housing 304. The swivels 504a and 504b provide a fixed point of contact with the top housing 304 and/or another component above the bottom housing 308. It is understood that other means of providing a fixed contact with the top housing 304 are possible. In some embodiments, the fixed swivel 508 is connected to the bottom housing 308 and may move freely as the top housing 304 is inclined. The fixed swivel 508 may abut and/or be attached to the top housing 304. In some embodiments, the fixed swivel 508 and the swivels 504a and 504b together form a triangular shape, enabling multi-axial movement and/or rotation of the adapter plate 302. In some embodiments, the fixed swivel 508 and the swivels 504a and 504b are positioned rotationally symmetrically about the center of the bottom housing 308.

The inclinometers 506a and 506b can sense the angle of the bottom housing 308. In some embodiments, the inclinometers 506a and 506b are arranged such that they are capable of sensing at an angle (e.g. orthogonally) with respect to each other such that they can measure along different axes. It is understood that less than or more than two inclinometers may be used, such as one or more, three or more, or four or more. In some embodiments according to the present disclosure, one or more of the inclinometers 506a and 506b are mounted to the circuit board 512.

The electronic 510 may be a microcontroller, microprocessor, stepper motor controller, or other components known in the art. It is understood that while the electronic 510 is shown within the bottom housing 308, in some embodiments the electronic 510 is located outside the bottom housing 308. In such embodiments, the electronic may communicate with the inclinometers 506a, 506b and/or the motors 502a, 502b by means known in the art, such as for example via Bluetooth, WiFi, and wired connection. In some embodiments according to the present disclosure, the electronic 510 is connected to the circuit board 512. The electronic is configured, in some embodiments, to receive and process data from the inclinometers 506a and 506b, such as the incline of the bottom housing 308, and that data can then be used to instruct the motors 502a and 502b to raise and/or lower in order to level a connected pyranometer 202.

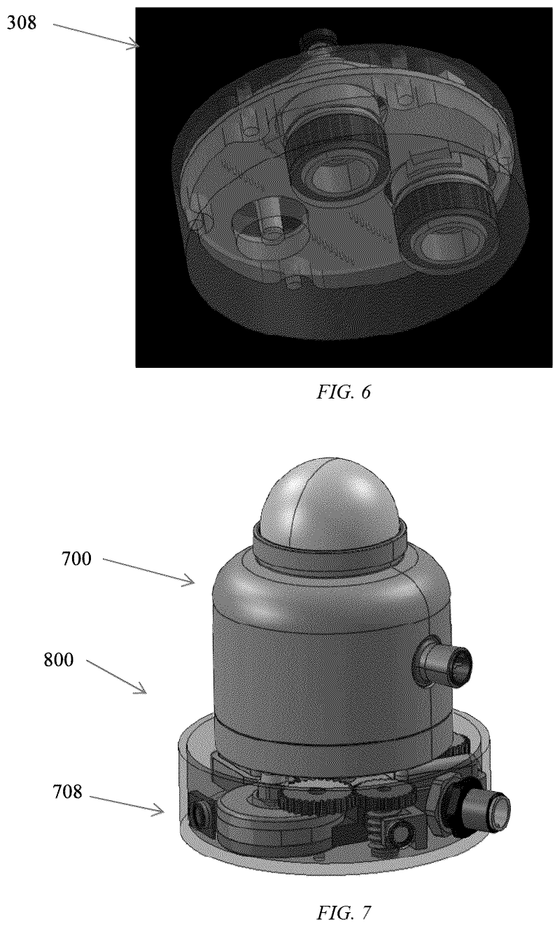

In some embodiments according to the present disclosure, the automatic leveling base 200 is configured to interface with a software, such as via a receiver, transmitter, and/or transceiver. In more specific embodiments, the electronic 510 is configured to communicate with a software via, for example, WiFi, Bluetooth, a wired connection, and/or other means known in the art. In some embodiments, an automatic leveling base 200 with an attached pyranometer 202 is configured to receive instructions a from software to incline the zero degrees pyranometer 202 to a specific angle, such as relative to the ground. The automatic leveling base 200 can then report to the software that it has achieved said specific angle. In more specific embodiments, the automatic leveling base 200 is mounted to one or more solar panels. The software can instruct the automatic leveling base 200 to incline the pyranometer 202 to an angle that matches the incline of one or more solar panels, thereby measuring the tilted solar irradiance of those one or more solar panels. In some embodiments, the software receives inclinometer data from the inclinometers 506a, 506b and instructs the automatic leveling base 200 to change its inclination. Many automatic leveling bases 200 with attached pyranometers 202 may be deployed in, for example, a solar panel array. In some embodiments with multiple leveling bases 200, the software can instruct different automatic leveling bases 200 to incline to different angles. In some embodiments, the software can instruct two or more automatic leveling bases 200 to incline to the same angles. In some embodiments, the automatic leveling base 200 with an attached pyranometer 202 is attached to a solar panel to sense the solar panel's tilted solar irradiance or to measure a different tilted solar irradiance that that incident to the solar panel. FIG. 6 shows a semitransparent bottom perspective view of the bottom housing 308.

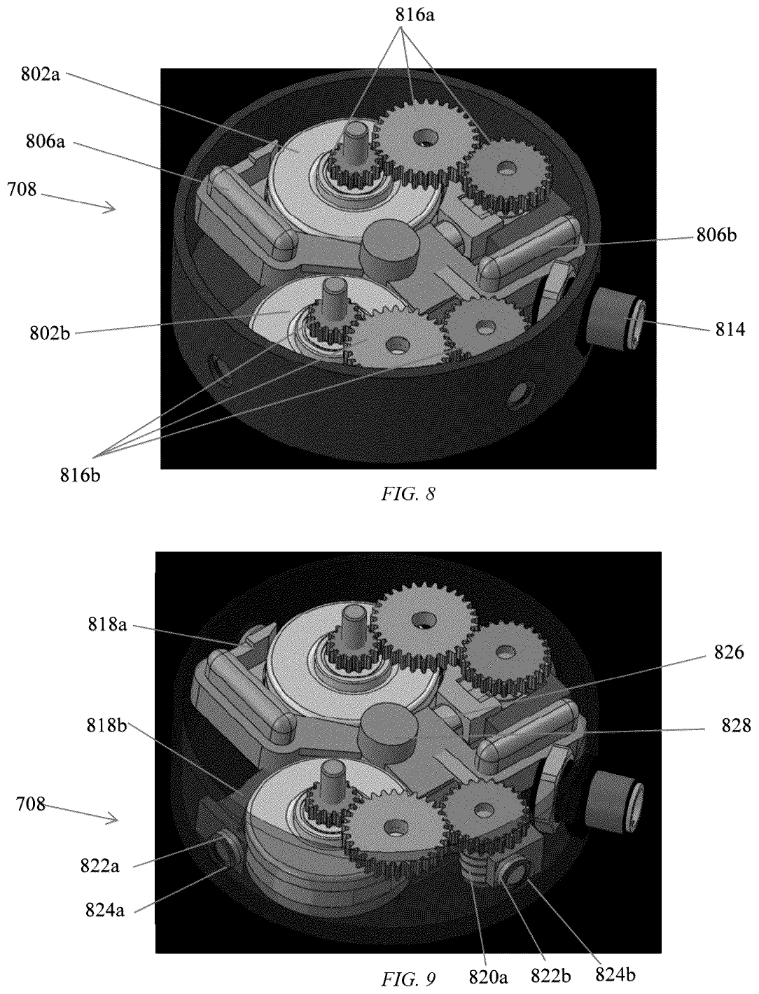

FIG. 7 shows a pyranometer 700, which may be the same as or similar to the pyranometer 202, and a bottom housing 708 of another embodiment of an automatic leveling base 800 according to the present disclosure. FIG. 8 shows the bottom housing 708 of the automatic leveling base 800 of the embodiment shown in FIG. 7. The automatic leveling base 800 can include an adapter plate 702 (not pictured in FIG. 8) that connects to the bottom of the pyranometer 700 and which can be the same as or similar to the adapter plate 302; a top housing 704 (also not pictured in FIG. 8) that can connect to the bottom of the adapter plate 302 and which can be the same as or similar to the top housing 304; bellows 706 (similarly not pictured in FIG. 8) that can be connected to the bottom of the top housing 704, which can be the same as or similar to the bellows 306; and a bottom housing 708 (discussed in further detail herein) that can be connected to the bottom of the bellows 706 and which can be the same as or similar to the bottom housing 308.

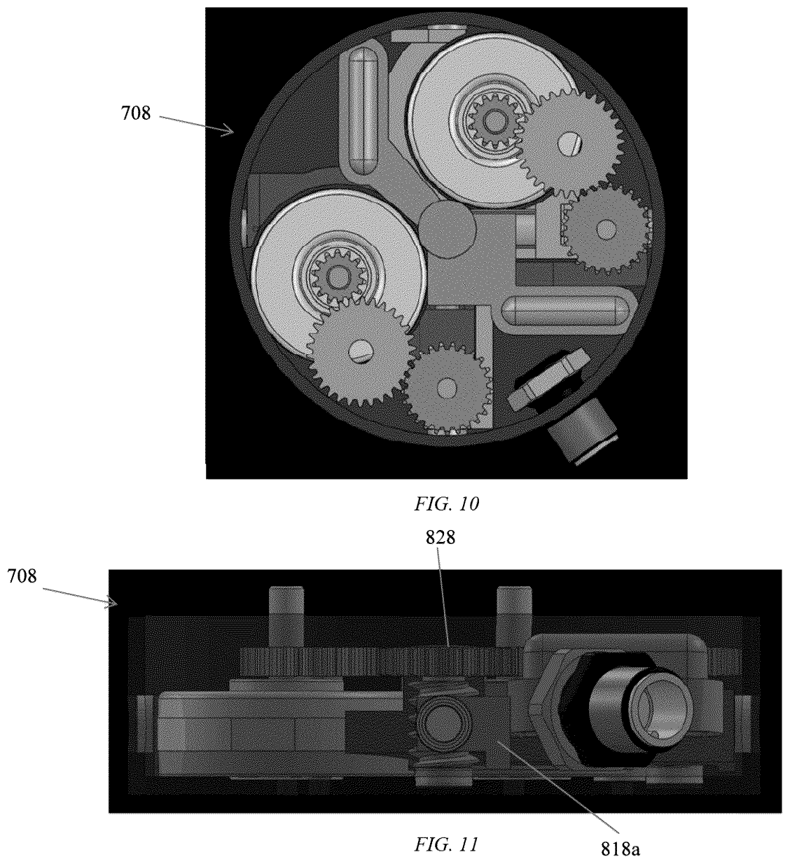

In some embodiments according to the present disclosure, the bottom housing 708 includes one or more motors 802a and 802b, which may be the same as or similar to the motors 502a and 502b, one or more inclinometers 806a and 806b, which may be the same as or similar to the inclinometers 506a and 506b, an electronic 810 (not pictured in FIGS. 7-12), which may be the same as or similar to the electronic 510, and a circuit board 812 (not pictured in FIGS. 7-12), which may be the same as or similar to the circuit board 512. The bottom housing may further include a connector 814, trains of gears 816a and 816b, linkages 818a and 818b, worm gears 820a and 820b, and bearings 822a-822d, which, in some embodiments, are located in holes 824a-824d formed in the bottom housing 708. It is understood that some embodiments may include multiple of any of these elements, or fewer than all of these elements, and may or may not include additional elements.

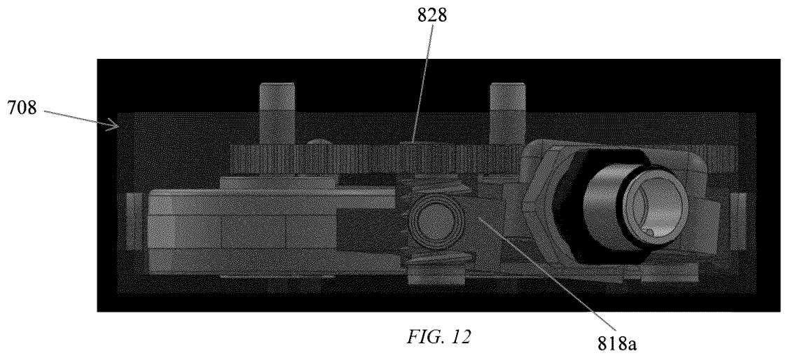

As shown in FIG. 9, the inclinometers 806a and 806b are mounted on a platform 826. The platform 826 is attached to the linkages 818a and 818b such that when the linkages 818a and/or 818b move, the platform 826 also moves. The platform 826 can include a post 828 (e.g., a central post) that is connected to the bottom of the adapter plate 702 such that movement of the platform 826 is transferred to the adapter plate 702, and in turn to the pyranometer 700. This movement is illustrated in FIGS. 11 and 12. In FIG. 11, the linkage 818a, and in turn the post 828, is parallel to the bottom housing 708. Conversely, the linkage 818a and the post 828 in FIG. 12 are inclined relative to the bottom housing 708.

In a specific embodiment, the motors 802a and 802b are stepper motors. The motors 802a and 802b are connected to the train of gears 816a, 816b, which in turn are connected to the worm gears 820a and 820b. The worm gears 820a and 820b engage with the linkages 818a and 818b to transfer rotation from the motors 802a and 802b to the linkages 818a and 818b. The motors 802a and 802b may be capable of moving independently of one another. By rotating the worm gears 820a and 820b via the motors 802a and 802b, and thereby rotating the linkages 818a and 818b, the angle of the platform 826 relative to the bottom housing 708 can be altered without the need for manual angle adjustment by a worker. While two motors 802a, 802b are shown in FIG. 8, it is understood that less or more motors are possible, such as one, three, four, or more motors. One of skill in the art would recognize that other components may be used rather than the trains of gears 816a and 818b in conjunction with the worm gears 820a, 820b to transfer movement of the motors 802a, 802b to the pyranometer 700, such as, for example, direct connection from the motors 802a, 802b to the top housing 704.

The inclinometers 806a and 806b can sense the angle of the platform 826. In some embodiments, the inclinometers 806a and 806b are arranged such that they are capable of sensing at an angle (e.g., orthogonally) with respect to each other and accordingly can measure along different axes. It is understood that less than or more than two inclinometers may be used, such as one or more, three or more, or four or more. In some embodiments according to the present disclosure, one or more of the inclinometers 806a and 806b are connected to the circuit board 812.

The electronic 810 may be a microcontroller, microprocessor, stepper motor controller, or other components known in the art. In some embodiments according to the present disclosure, the electronic 810 is contained within the bottom housing 708, and in other embodiments, the electronic 810 is located outside the bottom housing 708. In such embodiments, the electronic 810 may communicate with the inclinometers 806a, 806b and/or the motors 802a, 802b by means known in the art, such as via Bluetooth, WiFi, and/or wired connection via the connector 814. It is understood that, even in embodiments where the electronic 810 is contained within the bottom housing 708, the electronic—among other components—may communicate to other external electronics and software via the connector 814. In some embodiments according to the present disclosure, the electronic 810 is connected to the circuit board 812. The electronic 810 is configured, in some embodiments, to receive and process data from the inclinometers 806a and 806b, such as the incline of the bottom housing 708, and that data can then be used to instruct the motors 802a and 802b to raise and/or lower in order to level a connected pyranometer 700.

In some embodiments according to the present disclosure, the automatic leveling base 800 is configured to interface with a software, such as via a receiver, a transmitter, and/or a transceiver. The software may be, by way of example only, a supervisory control and data acquisition software with a Modbus protocol. In more specific embodiments, the electronic 810 is configured to communicate with a software via, for example, WiFi, Bluetooth, a wired connection through the connector 814, and/or other means known in the art. In some embodiments, an automatic leveling base 800 with an attached pyranometer 700 is configured to receive instructions from a software to incline the pyranometer 700 to a specific angle, such as zero degrees relative to the ground, after which the automatic leveling base 800 may incline the pyranometer 700 to said specific angle before reporting it has done so to the software. In more specific embodiments, the software instructs the automatic leveling base 800 to incline the pyranometer 700 to an angle that matches the incline of one or more solar panels, thereby measuring the tilted solar irradiance of those one or more solar panels. In some embodiments, the software receives inclinometer data from the inclinometers 806a, 806b and can instruct the automatic leveling base 800 to change its inclination. Many automatic leveling bases 800 with attached pyranometers 700 may be deployed in, for example, a solar panel array. In some embodiments with multiple leveling bases 800, the software can instruct different automatic leveling bases 800 to incline to different angles. In other embodiments, the software instructs two or more automatic leveling bases 800 to incline to the same angles. In some embodiments, the automatic leveling base 800 with an attached pyranometer 700 is attached to a solar panel to sense the solar panel's tilted solar irradiance or to measure a different tilted solar irradiance that that seen by the solar panel. In other embodiments, the automatic leveling base 800 with an attached pyranometer 700 is attached to an extension arm connected to a solar panel array such that the automatic leveling base 800 approximately matches the plane of array of the solar panels.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

We claim:

1. An automatic leveling base comprising:
an adapter plate;
a top housing on said adapter plate;
a bottom housing comprising an inclinometer and one or more motors; and
a bellows between said top housing and said bottom housing.

2. The automatic leveling base of claim 1, wherein one or more of the one or more motors are stepper motors.

3. The automatic leveling base of claim 2, wherein the one or more motors are configured to incline said adapter plate.

4. The automatic leveling base of claim 2, wherein the bottom housing further comprises an electronic configured to provide instructions to said one or more motors.

5. The automatic leveling base of claim 4, wherein the electronic is configured to communicate with a software.

6. The automatic leveling base of claim 2, wherein the bottom housing further comprises one or more swivels connected to said one or more motors.

7. The automatic leveling base of claim 2, wherein the bottom housing further comprises a fixed swivel connected to said top housing.

8. The automatic leveling base of claim 1, wherein the adapter plate is configured to attach to a pyranometer.

9. A system for measuring solar irradiance comprising:
an automatic leveling base comprising an adapter plate connected to a bottom housing, said bottom housing comprising an inclinometer and one or more motors; and
a pyranometer attached to said automatic leveling base,
wherein said one or more motors are configured to adjust an angle of said pyranometer.

10. The system of claim 9, wherein the bottom housing further comprises an electronic configured to provide instructions to the one or more motors.

11. The system of claim 10, wherein the data from said pyranometer is used to determine the angle of said one or more solar panels.

12. The system of claim 11, wherein said electronic is configured to communicate with a software.

13. The system of claim 12, wherein said automatic leveling base further comprises a top housing between said adapter plate and said bottom housing, and a bellows between said bottom housing and said top housing.

14. The system of claim 9, further comprising one or more solar panels connected to said automatic leveling base.

15. The system of claim 14, wherein said automatic leveling base is configured to incline said pyranometer to the same incline of said solar panel.

16. A method of measuring solar irradiance comprising:
inclining a pyranometer to a specific angle via an automatic leveling base; and
measuring the output of said pyranometer.

17. The method of claim 16, further comprising attaching said automatic leveling base to a solar panel.

18. The method of claim 16, wherein the specific angle is determined by a software.

19. The method of claim 16, wherein the specific angle is horizontal.

20. The method of claim 16, wherein the specific angle corresponds to the angle to which a solar panel is inclined.
